(19) United States
(12) Patent Application Publication
(10) Pub. No.: US 2008/0057233 A1
(43) Pub. Date: Mar. 6, 2008

(54) Conductive thermal transfer ribbon

(76) Inventors: Daniel J. Harrison, Pittsford, NY (US); Pamela A. Geddes, Alden, NY (US); Bernard Balling, Lockport, NY (US); Gregory Berube, Amherst, NY (US)

Correspondence Address: HOWARD J. GREENWALD P.C., 349 W. COMMERCIAL STREET SUITE 3075, EAST ROCHESTER, NY, 14445-2408, US

(21) Appl. No.: 11/894,229

(22) Filed: Aug. 20, 2007

Related U.S. Application Data
(60) Provisional application No. 60/840,732, filed on Aug. 29, 2006.

(51) Int. Cl. B41M 5/40

(52) U.S. Cl. 428/32.74

(57) ABSTRACT

A thermal transfer ribbon comprised of a support and an ink layer disposed above the support. The ink layer has a thickness of from about 0.1 to about 10 microns; it contains at least 75 weight percent of particulate conductive metal material and from about 1 to about 25 weight percent of binder; and it has a surface resistivity of less than about 1,000,000 ohms per square. When the ink layer is transferred to a substrate, the surface resistivity of the transferred ink is less than 100 ohms per square when printed onto a flexible substrate at a printing speed of 2 centimeters per second and a printing energy of 7.6 joules per square centimeter. The particulate conductive metal preferably contains a noble metal and has a melting point of at least 800 degrees Celsius and a particle size such that least about 95 weight percent of its particles are smaller than 50 microns.

### CROSS-REFERENCE TO RELATED PATENT APPLICATIONS

This patent application claims priority based upon U.S. patent application 60/840,732, filed on Aug. 29, 2006. The entire disclosure of this provisional patent application is hereby incorporated by reference into this specification.

### FIELD OF THE INVENTION

A conductive thermal transfer ribbon adapted to print an electrically conductive pathway onto a substrate.

### BACKGROUND OF THE INVENTION

The conventional means for forming electronic components on substrates are relatively expensive. Some of these prior art means were discussed in U.S. Pat. No. 7,062,848 of Alfred I-Tsung Pan et al. In column 1 of this patent, it was disclosed that: “Formation of electronic components and other conductive paths can be accomplished using a wide variety of known methods. Typical methods for manufacturing printed circuits include print and etch, screen printing, and photo-resist methods. Frequently these methods involve considerable capital costs and production time.”

In such column 1, Pan et al. also disclose that “A number of methods have been explored to decrease costs associated with producing electronic components. Some of these methods include using various conventional printing techniques to apply a conductive material, or a precursor thereof, to produce a useful electronic circuits. Yet many of these methods are often unreliable or otherwise undesirable for commercial scale production.”

The solution to this problem that is provided by the Pan et al. patent was to use a specified printable composition described, e.g., in claim 1 of the patent. Such claim 1 describes: “1. A printable composition, comprising: a) a liquid carrier; b) a plurality of nanostructures having an aspect ratio of at least about 5:1 within the liquid carrier; and c) a stabilizing agent configured to inhibit agglomeration of the plurality of nanostructures, said stabilizing agent being a nanostructure surface attached ligand, nanostructure polymeric coating, metal coating, semimetal oxide coating, or metal oxide coating.”

However, it does not appear that the composition of U.S. Pat. No. 7,062,848 can advantageously be used with a thermal transfer printer. The examples of such patent disclose the use of screen printing and ink jet printing; nowhere in the patent is the use of such composition with thermal transfer printing disclosed.

Several efforts have been described in the prior art to use a thermal transfer ribbon to print conductive traces onto a substrate. However, none of these efforts have been entirely successful. It is believed that one major problem that has been encountered is that, in order to thermally transfer material from a thermal transfer ribbon to a substrate, the heat of the thermal printhead must change the material's state (such as, e.g., by melting or softening) so that the material can wet and adhere to the substrate and then release from the ribbon.

A typical thermal transfer ribbon is described in U.S. Pat. No. 4,572,860, wherein, as is disclosed in lines 44 et seq. of column 5, “ . . . the composition ratio in the coloring agent layer of this invention is not limitative, but it is preferable to employ 50 to 90 parts of a heat fusible substance, 5 to 20 parts of a colorant and 0 to 30 parts of a resin (more preferably 5 to 30 parts), per 100 parts of the total amount of the coloring agent layer.” The coloring agent layer is thermally transferred from the ribbon to a desired substrate in a pattern governed by the placement of heat generated by a thermal printhead of the thermal transfer printer. Such heat from the printhead acts upon the thermal fusible components of the coloring ink layer causing them to melt and transfer to the substrate in an image wise fashion. By ensuring that the heat fusible components of said layer are in the majority, the thermal properties of the layer will be dominated by such components.

Prior art thermal transfer ribbons describe a wide variety of “transferable materials” including waxes, resins, plasticizers, polymers, colorants, particles and the like. Such thermally transferable layers are typically comprised of the following two classes of materials: (1) a continuous phase of heat meltable or softenable materials, and (2) a discontinuous phase of functional particles. While the continuous phase facilitates the thermal transfer imaging characteristics of the layer, the functional particles provide a desired property to the layer transferred. Such desired properties include color, magnetism, contrast, fluorescence, forensic identification, conductivity and the like. Examples of such functional particles include pigments, dyes, taggants, metal oxides, metals and the like.

Most prior art references teach that such functional particles should comprise a minority of the thermal transfer layer. Indeed, if the functional particles are higher in melting point than the continuous phase then the concentration of such particles in the layer will impact the overall thermal properties of the layer.

By way of illustration, U.S. Pat. No. 5,826,329 discloses thermal transfer ribbons comprised of electrically conductive materials such copper and silver. Such highly conductive materials as, e.g., copper (with a melting point of about 1,085 degrees Celsius) and silver (with a melting point of about 962 degrees Celsius) have much higher melting points than the waxes and/or resins used to facilitate the thermal transfer of such layer. Example 1 of U.S. Pat. No. 5,826,329 describes a transferable material that comprises 35 dry percent of copper powder and 65 dry percent of an organic epoxy resin binder. This material will be transferred by the heat from the thermal print head; however, it does not appear that the material so transferred will produce a printed layer with low enough electrical resistance for most printed electronics applications.

This “loading problem” has also been referred to in U.S. Pat. No. 5,041,331 of Glavin et al. which discussed the desirability of having loadings of at least 65 percent (or more) for ribbons for impact printing. At lines 37-44 of column 2 of this patent, it is disclosed that: “Typical ribbons used today for impact printing . . . generally have an ink coating which is on the order of 65% of more magnetic oxide.” Such a “loading” cannot be used in ribbons for thermal printing, as is disclosed at lines 44-48 of such column 2, wherein it is disclosed that: “Yet such loadings are clearly impossible in thermal transfer applications, where the ink layer must melt and transfer to the paper or document substrate, because the melting points of the magnetic oxides are several orders of magnitude higher than the general limit at 150° C. required to avoid melting the electrically resistive polymer substrate.” Thus, e.g., in thermal printing ribbon described in Example 1 of such patent, “ . . . the normal magnetic oxide loading of over 65% has been reduced to about 16% of the total ink composition, and less than 45% of the total non-volatile portion of the ink.”

U.S. Pat. No. 5,866,637 of Lorenz also indirectly refers to this “loading problem,” stating (at lines 31-36 of column 2) that: “While thermal transfer formulations and ribbons for MICR printing are known, inorganic metal oxide magnets are used to provide the necessary signal transmission for machine scanning. These inorganic metal oxides place limitations on the ribbon formulations and printed material produced.” The coating formulation described in Example 1 of such patent contained 10 weight percent of an “organic molecule-based magnet,” 20 weight percent of a binder resin, and 12 weight percent of a wax resin.

With most thermal transfer ribbons, the “support layer” is comprised of poly (ethylene terephthalate), which has a melting point of about 254 degrees Celsius. With such ribbons, loadings of greater than about 40 percent of high melting point materials (i.e., with melting points in excess of 900 degrees Celsius) in the ink layers are seldom found.

U.S. Pat. No. 4,991,287 of Piatt et al. describes a process for fabricating a printed circuit board in which a thermal transfer ribbon is used to print a mask pattern onto the metal surface of a metal coated dielectric substrate. The ribbon used is a “ . . . solder coated support ribbon . . . ” (see, e.g., claim 1.[b][3]) in which the support may be polyester (see the first paragraph of column 4), and in which the support is coated by a continuous layer of solder material, such as the “Indalloy” solders described in such column 4. The solder material transferred by the “preferred circuit printer 20” (see column 3 of the patent and FIG. 2) is not very conductive and would not be acceptable for printing commercially acceptable conductive traces onto a substrate with conventional thermal printers. While copper and silver have volume resistivities in the range of 1.7 microohm-cm, 50-50 solder has a resistivity that typically is an order of magnitude higher (see, e.g., page 12-234 of the 85^{th} edition of Handbook of Chemistry and Physics, CRC Press, New York, N.Y., 2004, wherein a “50-50 solder is reported to have a resistivity of 15 microohm centimeters). This limits the use of solder (and of the thermal transfer ribbon of Piatt et al.) to making short electrical connections and not long electrically conductive traces.

With the thermal transfer ribbons of U.S. Pat. Nos. 4,103,066, 4,991,287, and 5,826,329, the prior art attempted to transfer conductive material from a ribbon to a substrate. A different approach was described in U.S. Pat. No. 6,892,441 of Debraal, in which the material to be transferred was initially non-conductive but, during the printing process, allegedly became conductive. Thus, e.g., at page 8 of an amendment filed in patent application U.S. Ser. No. 09/839,126 on Jan. 7, 2004, the applicant of U.S. Pat. No. 6,892,441 distinguished his invention over the thermal printing ribbon of U.S. Pat. No. 5,826,329 of Roth by stating that: “It seems, however, that the Examiner is referred to lines 11-15 of the Roth patent. There it is stated that the coating 50 is an electrically conductive coating. In the present invention, on the other hand, the electrically conductor precursor is non-conductive. However, it becomes electrically conductive upon application of heat from the heat source . . . . With the present invention, the metallic salts which are employed are generally poor conductors which must be reduced by heating to form the conductive materials.”

The aforementioned amendment uses the term “reduced by heating.” Similar language is used in column 4 of U.S. Pat. No. 6,892,441 (at lines 34 et seq.) wherein it is disclosed that: “This coating is comprised of a reducible metallic material. . . . The primary component of the transfer layer is the reducible metallic material. The reducible material may be comprised of sorbitol copper formate, copper sulfate, cuprite, tenorite, silver nitrate, and the like.”

The terms “reduced” and “reducible” are not defined in U.S. Pat. No. 6,892,441. The conventional meaning of such the term “reduction” is that it is a process that is the opposite of oxidation, and that the “reducible material” loses electrons as it is being reduced. Thus, and as is disclosed at page 863 of “Hawley's Condensed Chemical Dictionary,” Eleventh Edition (Van Nostrand Reinhold Company, New York, N.Y., 1987), “The term ‘oxidation’ originally meant a reaction in which oxygen combines chemically with another substance, but its usage has long been broadened to include any reaction in which electrons are transferred. Oxidation and reduction always occur simultaneously (redox reactions), and the substance which gains electrons is termed the oxidizing agent.” In the redox reaction, the oxidizing agent is “reduced” (by gaining electrons); and, prior to gaining such electrons, it is “reducible.” Thus, at page 999 of the Hawley dictionary, reduction is defined as “(1) The opposite of oxidation. Reduction may occur in the following ways: (1) acceptance of one or more electrons by an atom or ion; (2) removal of oxygen from a compound; (3) addition of hydrogen to a compound . . . .”

Applicants do not understand how, when a ribbon comprised of a material selected from the group consisting of “ . . . sorbitol copper formate, copper sulfate, cuprite, tenorite, silver nitrate . . . ” is subjected a heated thermal print head during conventional thermal printing, such materials would be reduced by either accepting electrons, losing oxygen, or adding hydrogen. In any event, when a thermal transfer ribbon comprised of one or more materials selected from the group consisting of “ . . . sorbitol copper formate, copper sulfate, cuprite, tenorite, silver nitrate . . . ” is printed onto a substrate using conventional thermal transfer printing, the printed substrate does not have acceptable conductivity properties.

One of the problems with the use of “non conductive precursor material” in the ink layer of the thermal transfer ribbon is that such material does not help ameliorate the “static problem” discussed in U.S. Pat. No. 5,932,643. At is disclosed in the paragraph starting at line 59 of column 1 of such patent, “A common feature in these thermal transfer media is the use of a substrate for the ink to be transferred. Polyethylene terephthalate (PET) films are preferred substrates in that the property profile for PET (heat resistance, tensile strength, etc.) is well suited for use in conventional thermal transfer printers. One characteristic of most polymeric films, including PET films, is the generation of static electricity when rolls of these films are unwound. It has been discovered that static electricity from the thermal transfer ribbon can be a source of premature print head wear through static-electrostatic discharge. Therefore, reducing the static level of thermal transfer ribbons is desirable. Adding conductive fillers to non-conductive polymeric materials is known to reduce the static levels of such materials. However, adding such conductive fillers to polyethylene terephthalate is not always possible, particularly where obtained from another source and, furthermore, adding such conductive fillers may detract from the desirable properties of PET film.”

To the best of applicants knowledge, the prior art has not provided a thermal transfer ribbon with reduced static levels that is adapted to print conductive material on a substrate with conventional thermal transfer printers so that the printed substrate will have durable and stable highly conductive material transferred to it. It is an object of this invention to provide such a thermal transfer ribbon.

### SUMMARY OF THE INVENTION

In accordance with this invention, there is provided a thermal transfer ribbon comprised of a support and an ink layer disposed above the support. The ink layer has a thickness of from about 0.1 to about 10 microns; it is comprised of at least 75 weight percent of particulate conductive metal material and from about 1 to about 25 weight percent of binder; and it has a surface resistivity of less than about 1,000,000 ohms per square. When the ink layer is transferred to a substrate during conventional thermal transfer printing, the surface resistivity of the transferred ink is less than 100 ohms per square when printed onto a flexible substrate at a printing speed of 2 centimeters per second and a printing energy of 7.6 joules per square centimeter. The particulate conductive metal is preferably comprised of a noble metal and has a melting point of at least 800 degrees Celsius and a particle size such that least about 95 weight percent of its particles are smaller than 50 microns.

### BRIEF DESCRIPTION OF THE DRAWINGS

The invention will be described by reference to the specification and the following drawings, in which like numerals refer to like elements, and wherein:

FIG. 1 is a schematic of one preferred thermal transfer ribbon with a conductive ink layer adapted to print an electrically conductive pathway onto a substrate; and

FIG. 2 is a schematic of a thermal transfer ribbon adapted to print one or more security features onto a substrate.

FIG. 3 is a schematic of a thermal transfer ribbon adapted to print one or more conductive features onto a substrate.

### DESCRIPTION OF THE PREFERRED EMBODIMENTS

In one preferred embodiment, thermal transfer ribbon of this invention is comprised of a support and an ink layer disposed above the support. The thermally printed conductive ink layer preferably has a surface resistivity of less than about 50 ohms per square.

As is known to those skilled in the art, surface resistivity is the electrical resistance of the surface of a material, measured between the opposite sides of a surface of a square; the value, in ohms, is independent of the size of the square and the thickness of the surface film. Reference may be had, e.g., to page 1063 of the Fourth Edition of the “McGraw-Hill Dictionary of Scientific and Technical Terms” (McGraw-Hill Book Company, New York, N.Y., 1989). Reference may also be had to U.S. Pat. Nos. 3,935,458 (method for monitoring the surface resistivity of metalized film), 4,758,777 (surface resistivity meter), 5,391,994 (method for measuring surface resistivity using square electrodes and multiplying surface resistivity measurements by a correction factor), and 7,119,556 (probe for surface-resistivity measurement and method for measuring surface resistivity), and the like; the entire disclosure of each of these United States patents is hereby incorporated by reference into this specification. Reference also may be had, e.g., to published United States patent application 20060028216 (probe for surface-resistivity measurement and method for measuring surface resistivity), the entire disclosure of which is hereby incorporated by reference into this specification.

In one preferred procedure, surface resistivity is measured by a procedure that utilizes a Keithley Model 2010 7½-digit, low-noise, auto ranging digital multi-meter (obtained from MetricTest, Hayward, Calif.) using a four point probe (serrated tip probes obtained from Everett Charles Technologies, Los Angeles, Calif.) with the probes spaced 3.83 millieters from one another (11.5 millimeters from first to last probe, measured at the center line). A soft cloth may be used to gently polish the print prior to measuring the surface resistivity.

In one embodiment, surface resistivity is measured in accordance with A.S.T.M. Standard Test F1529-02.

The volume resistivity of such ink layer may be calculated from such surface resistivity. As used in this specification, and with reference to such ink layer, the volume resistivity is equal to the thickness of the conductive ink layer (in meters) times the surface resistivity of the ink layer, and it may be reported in milliohm meters.

Applicants' preferred conductive ink layer has a thickness of less than about 10 microns and, more preferably, less than about 5 microns. In one embodiment, the ink layer has a thickness of less than about 4 microns. In another embodiment, the ink layer has a thickness of less than about 3 microns. In yet another embodiment, the ink layer has a thickness of less than about 2 microns. As is known to those skilled in the art, a micron, also often referred to as a “micrometer,” is equal to 0.000001 meters of 0.0001 centimeters.

The conductive ink layer preferably is comprised of at least about 75 weight percent of particulate conductive metal material. As used herein, the term particulate refers to matter in the form of small liquid or solid particles with a maximum dimension of 25 microns. In one embodiment, the ink layer is comprised of at least about 95 percent of particulate conductive metal material with a maximum dimension of 10 microns.

In one embodiment, the particulate matter has a substantially spherical shape. In another embodiment, the particulate matter has a non-spherical shape. Examples of the latter embodiment include e.g., flakes, platelets. etc.

### A Preferred Flake Material for Use in the Thermal Transfer Ribbon

In one preferred embodiment, a silver-coated copper flake material is used in applicants' thermal transfer ribbon. This flake material may be made by preparing an ultra-fine copper flakes by a specified process and, thereafter, coating these flakes with silver material.

It is preferred to prepare the ultra-fine copper flakes by the process described in published United States patent application 20060207385, the entire disclosure of which is hereby incorporated by reference into this specification.

The process of such United States patent application 20060207385 is described, e.g., in claims 21-34 of such case.

Such claim 21 describes: “21. A method for forming a plurality of ultra-fine copper flakes comprising: (a) forming a system comprising the plurality of ultra-fine copper particles, a solvent, and a reducing agent; (b) milling the plurality of ultra-fine copper particles in the system; and optionally, (c) isolating the copper flakes.”

Claim 22 of such patent application describes: “22. The method of claim 21, wherein the solvent is propylene, glycol.” claim 23 of such patent application describes: “23. The method of claim 21, wherein the reducing agent is ascorbic acid.” claim 24 of such patent application describes: “24. The method of claim 21, wherein the system further comprises a lubricant. Claim 25 of such patent application describes: “25. The method of claim 24, wherein the lubricant is oleic acid.” claim 26 of such patent application describes: “26. The method of claim 21, wherein the system further comprises a dispersant.” claim 27 of such patent application describes: “27. The method of claim 26, wherein the dispersant is Solsperse 27000.” claim 28 of such patent application describes: “28. The method of claim 21, wherein the plurality of ultra-fine copper particles is milled at a temperature of at least about 65° C.” claim 29 of such patent application describes: “29. The method of claim 21, wherein the plurality of ultra-fine copper flakes is resistant to oxidation.” claim 30 of such patent application describes: “30. The method of claim 29, wherein the plurality of ultra-fine copper flakes undergoes minimal oxidation for 12 months in ambient environment, wherein oxidation is minimal when the oxygen content of the ultra-fine copper flakes is less than about 5-10% at the end of such period of time.” claim 31 of such patent application describes: “31. The method of claim 29, wherein the plurality of ultra-fine copper flakes undergoes minimal oxidation when exposed to temperatures up to 100° C. for about 120 minutes in air.” claim 32 of such patent application describes: “32. The method of claim 29, wherein the plurality of ultra-fine copper flakes undergoes minimal oxidation when heated in air at 20° C./minute up to 170° C.” claim 33 of such patent application describes: “33. The method of claim 21, wherein the ultra-fine copper flakes has a high dispersibility in a non-aqueous system.” claim 34 of such patent application describes: “34. The method of claim 21, wherein the non-aqueous system comprises at least one organic solvent.”

The product produced by the process of such United States patent application 20060207385 is also claimed in such application in, e.g., claims 1 to 6 thereof. Thus, e.g., claim 1 of such application describes: “1. A metallic composition comprising a plurality of ultra-fine copper flakes having a high dispersibility in a non-aqueous system.” claim 2 of such application describes: “2. A metallic composition comprising a plurality of ultra-fine copper flakes, wherein the plurality of ultra-fine copper flakes is resistant to oxidation.” claim 3 of such application describes: “3. The metallic composition of claim 2, wherein the plurality of ultra-fine copper flakes undergoes minimal oxidation for 12 months in ambient environment, wherein oxidation is minimal when the oxygen content of the ultra-fine copper flakes is less than about 5-10% at the end of such period of time.” claim 4 of such application describes: “4. The metallic composition of claim 2, wherein the plurality of ultra-fine copper flakes undergoes minimal oxidation when exposed to temperatures up to 100° C. for about 120 minutes in air.” claim 5 of such application describes: “5. The metallic composition of claim 2, wherein the plurality of ultra-fine copper flakes undergoes minimal oxidation when heated in air at 20° C./minute up to 170° C.” claim 6 of such application describes: “6. The metallic composition of claim 2, wherein the non-aqueous system comprises at least one organic solvent.”

It is preferred that the copper flakes produced in accordance with the process of published United States patent application 20060207385 be coated with a thin coating of silver. In general, from about 5 to about 40 weight percent of silver, by total weight of silver and copper, is used to coat the copper. In one aspect of this embodiment, from about 10 to about 20 weight percent of silver is used to coat the copper. In one embodiment, the thickness of the silver coating on the copper flakes is from about 0.1 to about 1.0 micron and, preferably, from about 0.3 to about 0.7 microns.

The silver may be coated onto the copper flakes by conventional silver coating techniques. Reference may be had, e.g., to Canadian patent 1792928 and Japanese patent 60100679A2 (method for coating silver to metallic material), the entire disclosure of each of which is hereby incorporated by reference into this specification. The Japanese patent describes: “ . . . A metallic material consisting of copper, iron, nickel, stainless steel or the like in a powder, fiber or plate form is treated by a dipping method, spraying method, etc. using a chemical plating liquid which contains silver sulfate and aminocarboxylic acids such as aminocarboxylic acid or the like and is adjusted to ≧6, more preferably 6W11 pH by an alkali metal carbonate such as sodium carbonate or the like, by which a metallic silver coating is formed on the surface of said metallic material. Ethylenediaminetetraacetic acid, nitrilotriacetate, hydroxyethylethylenediaminetriacetic acid, ethylenetriaminepentaacetic acid, triethylenetetraminehexaacetic acid, hydroxyethyliminediacetic acid, dihydroxyethyl glycine, etc. are adequately used for the above-mentioned aminocarboxylic acid.”

One may use any of the silver-coated copper flake materials that are commercially available. Thus, e.g., and as is disclosed in published United States patent application US10050287316 (the entire disclosure of which is hereby incorporated by reference into this specification), ““Silver Coated Copper Flake—450” is available from Ferro Electronic Material Systems, So. Plainfield, N.J.). These silver coated copper flakes used have 90% of particles with a diameter of 18.03 microns.

By way of further illustration, silver coated copper flakes are referred to in the specification and claims of U.S. Pat. Nos. 6,013,203 (coatings for EMI/RFI shielding), 6,375,866 (method for applying a conductive coating), and the like. The entire disclosure of each of these United States patents is hereby incorporated by reference into this specification.

In one embodiment, the silver coated metallic flake material is purchased from the NanoDynamics Corporation of 901 Fuhrmann Blvd., Buffalo, N.Y. as product AC1-10510, “ND Copper Flake, Silver Coated . . . ”

The preferred silver coated metallic flake material has a tap density of from about 2 to about 3 grams per cubic centimeter and, more preferably, from about 2.2 to about 2.6 grams per cubic centimeter. This material preferably has a specific surface area of from about 1 to about 2 square meters per gram and, more preferably, from about 1.3 to about 1.7 square meters per gram. In one embodiment, at least 85 percent of the particles are smaller than 10 microns, at least 45 percent of the particles are smaller than 6 microns, and at least 5 percent of the particles are smaller than 3 microns.

### A Preferred Silver Flake Material

In one preferred embodiment, the metallic material used in the ink is a silver flake material. Silver flake material is well known to those skilled in the art and is described, e.g., in the specifications and claims of U.S. Pat. Nos. 4,407,674 (novel electroconductive compositions), 4,911,796 (plated through-holes in a printed circuit board), 5,156,772 (circuit writer materials), 5,417,745 (silver containing conductive coatings), 5,744,285 (composition for filling vias), and the like. The entire disclosure of each of these United States patents is hereby incorporated by reference into this specification.

Thus, e.g., U.S. Pat. No. 5,417,796 discloses that: “The silver flakes are usually chemically precipitated silver powders that have been mechanically flattened (usually by some form of impact process such as ball milling) to achieve desired physical properties. The flakes have the following recommended physical properties: Tap Density: 1.60-4.90 g/cc, preferably 2.0-2.7 g/cc Surface Area: 0.15-1.20 m2/g, preferably 0.3-0.8 m2/g Apparent Density: 15.0-44.0 g/in3, preferably 27.0-42.0 g/in3 Particle Size>99% through 325 mesh.” The silver flake material is commercially available. Thus, e.g., one may purchase such material from (as silver flake powders, e.g., F14, D21, D12 or D35) from the Ferro Corporation of 1000 Lakeside Avenue, Cleveland, Ohio.

A variety of silver flake materials may be purchased from the Ames Goldsmith Corporation of 21 Roger Street, Glen Falls, N.Y. as products 1036, 1024, 4320, 4300, 4309, 4315C, LCP 1-8, LCP 1-9 VS, AND lcp1-19 SFS. These materials generally have silver contents of at least 99 percent, tap densities of from about 2 to about 5, and surface areas from about 0.35 to about 1.6 square meters per gram.

In one embodiment, a silver flake is purchased from the Ferro Corporation of 1000 Lakeside Avenue, Cleveland, Ohio as “Silver Flake #77A.” This product has a tap density of 2 to 4 grams per cubic centimeter, a specific surface area of from 1.5 to 2.6 square meters per gram, and a particle size distribution such that at least 90 weight percent of its particles are smaller than 10 microns, and at least 45 weight percent of its particles are smaller than 2.0 microns.

### A Preferred Silver Powder for Use in the Conductive Ink

In one embodiment, silver powder is used in the conductive ink. This powder preferably has a particle size distribution that at least 95 weight percent of its particles are smaller than 1 micron and, preferably, smaller than 100 nanometers; and this powder preferably has a specific surface area of at least about 1 square meter per gram and, more preferably, at least about 8 square meters per gram.

These fine silver powders may be made by processes well known to those skilled in the art. Thus, e.g., one may use the process described in published United States patent application 20060090598, the entire disclosure of which is hereby incorporated by reference into this specification. Thus, e.g., claim 23 of this patent application describes: “23. A method for forming a plurality of ultra-fine silver particles comprising: (a) obtaining a reducing solution comprising a reducing agent and a stabilizing agent; (b) obtaining a silver-ammonia solution comprising a silver-ammonia complex; (c) forming a reaction mixture comprising the reducing solution and the silver-ammonia solution; (d) maintaining the reaction mixture under a suitable condition for a time effective to reduce the silver-ammonia complex to silver particles; and optionally, (e) isolating the silver particles.”

By way of further illustration, one may use the processes and/or compositions described in U.S. Pat. Nos. 4,039,317 (process for the preparation of silver powder), 4,186,244 (novel silver powder composition), 4,273,583 (flake silver powders with chemisorbed monolayer of dispersant), 4,439,468 (platinum coated silver powder), 4,456,473 (method of making silver powder), 4,456,474 (method of making fine silver powder), and the like. One also may use the process described in published United States patent application US 20060090600. The entire disclosure of each of these United States patent documents is hereby incorporated by reference into this specification.

In one embodiment, the silver powder used is purchased from the NanoDynamics Corporation as “NDSilver Powder.” It has an average particle size of 53 nanometers, a tap density of 2.6 grams, per cubic centimeter, and a specific surface area of 8.94 square meters per gram.

In one embodiment, it is preferred that the particulate conductive metal have a volume resistivity of less than about 10 microohm-centimeters. As is known to those skilled in the art, and as is described in, e.g., e.g., A.S.T.M. D1566 and A.S.T.M. D-11, the volume resistivity is the ratio of the steady state direct voltage gradient parallel to the current to the steady state current density within the material. These volume resistivities may be determined by conventional means. Reference may be had, e.g., to U.S. Pat. Nos. 3,990,098, 4,008,721, 4,140,461, 5,873,018, 6,085,415, and the like. The

In addition to the particulate conductive metal material, the conductive ink layer is also comprised of from about 1 to about 25 weight percent of binder. In one embodiment, the conductive ink layer comprises less than about 15 weight percent of such binder. In another embodiment, such conductive ink layer comprises from about 1 to about 10 weight percent of such binder.

In one embodiment, it is preferred that the conductive metal particles are comprised of one or more elements that has a reduction potential of at least about 0.5 volts at 25 degrees Celsius and 1 atmosphere pressure, and preferably at least about 0.7 volts. This reduction potential, also known as “redox potential,” refers to the potential of a reversible oxidation-reduction electrode measured with respect to a reference electrode, corrected to the hydrogen electrode, in a given electrolyte. The reduction potential of various elements is well known to those skilled in the art and is described in many textbooks. See, e.g., page 8-23 of the 85^{th} edition of the Handbook of Chemistry and Physics, supra. As is described on such page, the E° value (E°/V) is measured at 25 degrees Celsius and 1 atmosphere. Reference also may be had, e.g., to Table 6-2 (see pages 6-6 et seq.) of “Lange's Handbook of Chemistry and Physics,” Thirteenth Edition (McGraw-Hill, New York, N.Y., 1985) which describes the “potentials of the elements and their compounds at 25° C.”

In one preferred embodiment, the particulate conductive metal material is comprised of one or more noble metals. As is known to those skilled in the art, and noble metal is a metal selected from the group consisting of silver, gold, platinum, palladium, iridium, rhenium, mercury, ruthenium, and osmium. In this embodiment, it is preferred that at least 5 weight percent of the particulate material be a noble metal, and it is more preferred that at least about 10 weight percent of such material comprise a noble metal. In one aspect of this embodiment, at least about 20 weight percent of the material is a noble metal. In another embodiment, at least about 50 weight percent of the material is a noble metal. In yet another embodiment, at least about 95 weight percent of the material is a noble metal.

In one embodiment, the noble metal is comprised of a material selected from the group consisting of silver, gold, and mixtures thereof. In one aspect of this embodiment, in addition to the noble metal, the particulate material also comprises another conductive metal, such as copper, nickel, aluminum, chrome, zinc, iron, tin, molybdenum, tungsten, and the like. In this aspect, it is preferred to coat such other conductive metal with the silver and/or the gold and/or one or more of the other noble metals

### A Thermal Transfer Ribbon Comprised of Conductive Ink

In one preferred embodiment, the thermal transfer ribbon of this invention is used to directly or indirectly prepare a digitally printed conductive image. As is known to those skilled in the art, conductivity is a property of a material enabling it to transport electrons with minimal resistance.

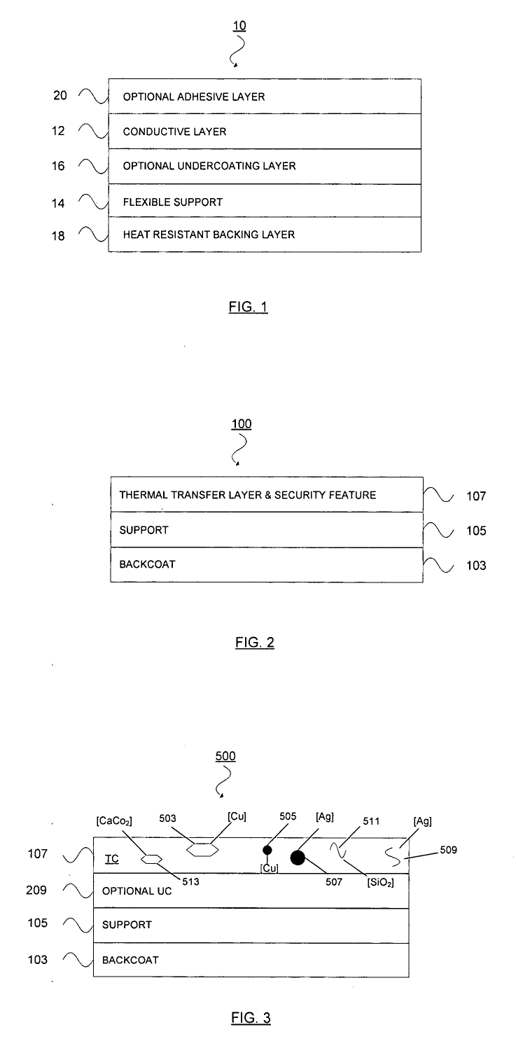

FIG. 1 is a schematic representation of one preferred thermal ribbon 10 comprised of a conductive ink layer 12. The ribbon depicted in this FIG. 1 is prepared in substantial accordance with the procedure described elsewhere in this specification.

In one embodiment, the conductive ink layer 12 is preferably comprised of from about 1 to about 50 weight percent of a solid, thermoplastic binder; in one aspect of this embodiment, the conductive ink layer is comprised of from about 2 to about 20 weight percent of such solid, thermoplastic binder.

As used herein, the term thermoplastic refers to a material which is composed of polymers, resins, rubbers, waxes and plasticizers. One may use any of the thermal transfer binders known to those skilled in the art. Thus, e.g., one may use one or more of the thermal transfer binders disclosed in U.S. Pat. Nos. 6,127,316, 6,124,239, 6,114,088, 6,113,725, 6,083,610, 6,031,556, 6,031,021, 6,013,409, 6,008,157, 5,985,076, and the like. The entire disclosure of each of these United States patents is hereby incorporated by reference into this specification.

By way of further illustration, one may use a thermoplastic binder which preferably has a softening point from about 45 to about 150 degrees Celsius and a multiplicity of polar moieties such as, e.g., carboxyl groups, hydroxyl groups, chloride groups, carboxylic acid groups, urethane groups, amide groups, amine groups, urea, epoxy resins, and the like. Some suitable binders within this class of binders include polyester resins, bisphenol-A polyesters, polyinyl chloride, copolymers made from terephthalic acid, polymethyl methacrylate, vinylchloride/vinylacetate resins, epoxy resins, polyamides, nylon resins, urethane-formaldehyde resins, polyurethane, mixtures thereof, and the like.

In one embodiment, the thermoplastic binder is a resin obtained from the Arizona Chemical Corporation of Jacksonville, Fla. One may use one or more of the resins described in such company's U.S. Pat. Nos. 4,830,671 (ink compositions for inkjet printing), 5,194,638 (resinous binders for use ink in compositions), 5,455,326 (inkjet printing compositions), 5,645,632 (diesters of polymerized fatty acids useful as hot melt inks), 6,492,458 (polalkylenediamine polyamides), and the like. The entire disclosure of each of these United States patents is hereby incorporated by reference into this specification.

In one embodiment, the Arizona Chemical product used is Uni-Rez 2980, a polyesteramide resin.

In one embodiment, the binder is comprised of polybutylmethacrylate and polymethylmethacrylate, comprising from 10 to 30 percent of polybutylmethacrylate and from 50 to 80 percent of the polymethylacrylate. In one embodiment, this binder also is comprised of cellulose acetate propionate, ethylenevinylacetate, vinyl chloride/vinyl acetate, urethanes, etc. One may obtain these binders from many different commercial sources. Thus, e.g., some of them may be purchased from Dianal America of 9675 Bayport Blvd., Pasadena, Tex. 77507; suitable binders available from this source include “Dianal BR 113” and “Dianal BR 106.” Similarly, suitable binders may also be obtained from the Eastman Chemicals Company (Tenn. Eastman Division, Box 511, Kingsport, Tenn.).

Referring again to FIG. 1, the conductive layer 12 may optionally contain from about 0 to about 75 weight of wax and, preferably, 5 to about 20 percent of such wax. In one embodiment, layer 12 is comprised of from about 5 to about 10 weight percent of such wax. Suitable waxes which maybe used include carnuaba wax, rice wax, beeswax, candelilla wax, montan wax, paraffin wax, microcrystalline waxes, synthetic waxes such as oxidized wax, ester wax, low molecular weight polyethylene wax, Fischer-Tropsch wax, and the like. These and other waxes are well known to those skilled in the art and are described, e.g., in U.S. Pat. No. 5,776,280. One may also use ethoxylated high molecular weight alcohols, long chain high molecular weight linear alcohols, copolymers of alpha olefin and maleic anhydride, polyethylene, polypropylene,

These and other suitable waxes are commercially available from, e.g., the Baker-Hughes Baker Petrolite Company of 12645 West Airport Blvd., Sugarland, Tex.

In one preferred embodiment, carnuaba wax is used as the wax. As is known to those skilled in the art, carnuaba wax is a hard, high-melting lustrous wax which is composed largely of ceryl palmitate; see, e.g., pages 151-152 of George S. Brady et al.'s “Material's Handbook,” Thirteenth Edition (McGraw-Hill Inc., New York, N.Y., 1991). Reference also may be had, e.g., to U.S. Pat. Nos. 6,024,950, 5,891,476, 5,665,462, 5,569,347, 5,536,627, 5,389,129, 4,873,078, 4,536,218, 4,497,851, 4,4610,490, and the like. The entire disclosure of each of these United States patents is hereby incorporated by reference into this specification.

Conductive ink layer 12 may also be comprised of from about 0 to 16 weight percent of plasticizers adapted to plasticize the resin used. Those skilled in the art are aware of which plasticizers are suitable for softening any particular resin. In one embodiment, there is used from about 1 to about 15 weight percent, by dry weight, of a plasticizing agent. Thus, by way of illustration and not limitation, one may use one or more of the plasticizers disclosed in U.S. Pat. No. 5,776,280 including, e.g., adipic acid esters, phthalic acid esters, chlorinated biphenyls, citrates, epoxides, glycerols, glycol, hydrocarbons, chlorinated hydrocarbons, phosphates, esters of phthalic acid such as, e.g., di-2-ethylhexylphthalate, phthalic acid esters, polyethylene glycols, esters of citric acid, epoxides, adipic acid esters, and the like.

In one embodiment, layer 12 is comprised of from about 6 to about 12 weight percent of the plasticizer which, in one embodiment, is dioctyl phthalate. The use of this plasticizing agent is well known and is described, e.g., in U.S. Pat. Nos. 6,121,356, 6,117,572, 6,086,700, 6,060,214, 6,051,171, 6,051,097, 6,045,646, and the like. The entire disclosure of each of these United States patent applications is hereby incorporated by reference into this specification. Suitable plasticizers may be obtained from, e.g., the Eastman Chemical Company.

The conductive ink layer 12 is preferably comprised of 50 to 99 weight percent of conductive metal particles. Metal particles such as those disclosed in pending Untied States Patent Applications 20060090600, 20060090598 and 20060207385 may be used.

The conductive ink layer 12 may also optionally comprise from about 0.001 to about 1 weight percent of a dispersing agent which, preferably, is an anionic dispersing agent. Thus, e.g., one may use DISPERBYK-111, an anionic copolymer with acidic groups that has an acid value of 129 millequivalents of KOH/gram.

Referring again to FIG. 1, it will be seen that ribbon 10 comprises the conductive ink layer 12 that may be deposited onto a substrate by conventional means. A conductive ink is preferably coated onto such substrate, such as a polyester substrate, at a coating weight of from about 1 to about 15 grams per square meter. In one embodiment, the coating weight of the conductive ink layer 12 is from about 2 to about 10 grams per square meter. In another embodiment, the coating weight of the conductive ink layer 12 is from about 3 to about 8 grams per square meter.

Referring again to FIG. 1, the flexible support 14 is preferably comprised of biaxially oriented polyester film with has a thickness of from about 2.5 to about 15 microns. The conductive ink is preferably coated onto such polyester support 14 by a gravure cylinder, or a Myer rod, etc. Reference to this coating process is made, e.g., elsewhere in this specification.

Referring again to FIG. 1, the conductive thermal transfer ribbon 10 may optionally comprise an undercoating layer 16. This undercoat layer 16 is preferably comprised of at least about 75 weight percent of one or more of the waxes and thermo plastic binders described elsewhere in this specification, and it preferably has a coating weight of from about 0.1 to about 2.0 grams per square meter.

Referring to FIG. 1, and in the preferred embodiment depicted therein, it will be seen that substrate 14 contains an optional undercoat 16 coated onto the top surface of the substrate. The undercoat 16, when used, facilitates the release of the thermal transfer layer 12 from substrate 14 when a thermal ribbon 10 is used to digitally print.

Undercoat 16 preferably has a thickness of from about 0.2 to about 1.5 microns and typically is comprised of at least about 50 weight percent of wax. Suitable waxes which may be used include, e.g., carnuaba wax, rice wax, beeswax, candelilla wax, montan wax, paraffin wax, mirocrystalline waxes, synthetic waxes such as oxidized wax, ester wax, low molecular weight polyethylene wax, Fischer-Tropsch wax, and the like. These and other waxes are well known to those skilled in the art and are described, e.g., in U.S. Pat. No. 5,776,280, the entire disclosure of which is hereby incorporated by reference into this specification.

In one embodiment, at least about 75 weight percent of layer 16 is comprised of wax. In one aspect of this embodiment, the wax used is preferably carnuaba wax.

Minor amounts of other materials may be present in layer 16. Thus, one may include from about 5 to about 20 weight percent of heat-softening resin which softens at a temperature of from about 60 to about 150 degrees Centigrade. Some suitable heat-softening resins include, e.g., the heat-meltable resins described in columns 2 and of U.S. Pat. No. 5,525,403, the entire disclosure of which is hereby incorporated by reference into this specification. In one embodiment, the heat-meltable resin used is polyethylene-co-vinylacetate with a melt index of from about 40 to about 2500 dg. per minute.

Referring again to FIG. 1, and affixed to the bottom surface of flexible substrate 14 is heat resistant backing layer 18, which is similar in function to the “backside layer” described at columns 2-3 of U.S. Pat. No. 5,665,472, the entire disclosure of which is hereby incorporated by reference into this specification. The function of this backing layer 18 is to prevent blocking between a thermal backing sheet and a thermal head and, simultaneously, to improve the slip property of the thermal backing sheet.

The heat resistant backing layer 18 preferably has a coating weight of from about 0.02 to about 1.0 grams per square meter. Backing layer 18, and the other layers which form the ribbons of this invention, may be applied by conventional coating means. Thus, by way of illustration and not limitation, one may use one or more of the coating processes described in U.S. Pat. Nos. 6,071,585 (spray coating, roller coating, gravure, or application with a kiss roll, air knife, or doctor blade, such as a Meyer rod), 5,981,058 (myer rod coating), 5,997,227, 5,965,244, 5,891,294, 5,716,717, 5,672,428, 5,573,693, 4,304,700, and the like. The entire disclosure of each of these United States patents is hereby incorporated by reference into this specification.

Thus, e.g., backing layer 18 may be formed by dissolving or dispersing the above binder resin containing additive (such as a slip agent, surfactant, inorganic particles, organic particles, etc.) in a suitable solvent to prepare a coating liquid. Coating the coating liquid by means of conventional coating devices (such as Gravure coater or a wire bar) may then occur, after which the coating may be dried.

One may form a backing layer 18 of a binder resin with additives such as, e.g., a slip agent, a surfactant, inorganic particles, organic particles, etc.

Binder resins usable in the layer 18 include, e.g., cellulosic resins such as ethyl cellulose, hydroxyethylcellulose, hydroxypropylcellulose, methylcellulose, cellulose acetate, cellulose acetate butyrate, and nitrocellulose. Vinyl resins, such as polyvinylalcohol, polyvinylacetate, polyvinylbutyral, polyvinylacetal, and polyvinylpyrrolidone also may be used. One also may use acrylic resins such as polyacrylamide, polyacrylonitrile-co-styrene, polymethylmethacrylate, and the like. One may also use polyester resins, silicone-modified or fluorine-modified urethane resins, and the like.

In one embodiment, the binder comprises a cross-linked resin. In this case, a resin having several reactive groups, for example, hydroxyl groups, is used in combination with a crosslinking agent, such as a polyisocyanate, an epoxy, an oxazoline and the like.

In one embodiment, a backing layer 18 is prepared and applied at a coat weight of 0.05 grams per square meter.

One may apply backing layer 18 at a coating weight of from about 0.01 to about 2 grams per square meter, with a range of from about 0.02 to about 0.4 grams/square meter being preferred in one embodiment and a range of from about 0.5 to about 1.5 grams per square meter being preferred in another embodiment.

Referring again to FIG. 1, it will be seen that ribbon 10 may optionally comprise an adhesive layer 20. These adhesive layers are well known with respect to thermal transfer ribbons. Reference may be had, e.g., to several patents assigned to the Fujicopian corporation that describe and claim such adhesive layers, including, e.g., U.S. Pat. Nos. 5,525,403 (thermal transfer printing medium), 5,605,766 (thermal transfer recording medium), 5,700,584 (thermal transfer recording medium), 6,080,479 (thermal transfer recording medium), 6,231,973 (thermal transfer recording medium), 6,562,442 (metallic thermal transfer recording medium), 6,623,589 (color thermal transfer recording medium), and the like. The entire disclosure of each of these United States patents is hereby incorporated by reference into this specification.

FIG. 2 is a schematic illustration of a thermal transfer ribbon 100 that may be made in accordance with the process of this invention. Although a particular process is described elsewhere in this specification to prepare this thermal transfer ribbon 100, other “prior art” processes also may be used.

Illustrative of the “prior art” processes that may be used to prepare such thermal transfer ribbons are such patent publications as U.S. Pat. Nos. 5,244,861 (receiving element for use in thermal dye transfer), 5,369,077 (thermal dye transfer receiving element), 5,466,658 (thermal dye receiving element for mordanting ionic dyes), 5,604,078 (receiving element for use in thermal dye transfer), 5,627,128 (thermal dye transfer system with low TG polymeric receiver mixture), 5,627,169 (stabilizers for receiver used in thermal dye transfer), 5,748,204 (hybrid imaging system capable of using ink jet and thermal dye transfer imaging technologies on a single image receiver), 5,753,590 (thermal dye transfer assemblage with low Tg polymeric receiver mixture), 5,795,844 (dye sets for thermal imaging having improved color gamut), 5,830,824 (plasticizers for dye-donor element used in thermal dye transfer), 5,888,013 (re-application of a dye to a dye donor element of thermal printers), 5,945,376 (thermal dye transfer assemblage with low Tg polymeric receiver mixture), 6,481,353 (process for preparing a ceramic decal), 6,629,792 (thermal transfer ribbon with frosting ink layer), 6,666,596 (re-application of a dye to a dye donor element of thermal printers), 6,694,885 (thermal transfer system for fired ceramic decals), 6,722,271 (ceramic decal assembly), 6,766,734 (transfer sheet for ceramic imaging), 6,796,733 (thermal transfer ribbon with frosting ink layer), 6,854,386 (ceramic decal assembly), 6,908,240 (thermal printing and cleaning assembly), as well as published United States patent applications 20010041084 (re-application of dye to a dye donor element of thermal printers), 20030200889 (thermal transfer system for fired ceramic decals), 20040003742 (transfer sheet for ceramic imaging), 20040136765 (thermal transfer ribbon with frosting ink layer), 20040149154 (ceramic decal assembly), 2005005618 (ceramic decal assembly), 20050128280 (thermal printing and cleaning assembly), 20050129445 (thermal printing and cleaning assembly), 20050129446 (thermal printing and cleaning assembly), 20050145120 (thermal transfer assembly for ceramic imaging), 20050150412 (thermal transfer assembly for ceramic imaging), and 200505016677 (thermal transfer assembly for ceramic imaging), The entire disclosure of each of these United States patents and published patent applications is hereby incorporated by reference into this specification.

By way of further illustration, one may use one or more of the thermal transfer processes, ribbons, reagents, and/or devices disclosed in U.S. Pat. Nos. 4,627,997 (thermal transfer recording medium), 4,472,479 (light barrier fluorescent ribbon), 4,816,344 (preparation of fluorescent thermal transfer ribbon), 4,891,352 (thermally-transferable fluorescent 7-aminocarbostyrils), 5,089,350 (thermal transfer ribbon), 5,135,569 (ink composition containing fluorescent component and method of tagging articles therewith), 5,328,887 (thermally transferable fluorescent compounds), 5,516,590 (fluorescent security thermal transfer printing ribbons), 5,486,022 (security threads having at least two security detection features), 5,516,590 (fluorescent security thermal transfer printing ribbons), 5,583,631 (anticounterfeit security device including two security elements), 5,601,931 (object to be checked for authenticity), 5,786,587 (enhancement of chip card security), 5,803,503 (magnetic metallic safeguarding thread with negative writing), 5,844,230 (information card), 5,949,050 (magnetic cards having a layer being permanently magnetized in a fixed configuration), 6,174,400 (near infrared fluorescent security thermal transfer printing and marking ribbons), 6,255,948 (security device having multiple security features and method of making same), 6,376,056 (thermo-transfer ribbon for luminescent letters), 6,491,324 (safety document), 6,633,370 (quantum dots, semiconductor nanocrystals, and semiconductor particles used as fluorescent coding elements), 6,686,074 (secured documents identified with anti-stokes fluorescent compositions), 6,802,992 (non-green anti-stokes luminescent substance), 6,841,092 (anti-stokes fluorescent compositions and methods of use), 6,926,764 (ink set, printed articles, a method of printing, and a colorant), 6,930,606 (security device having multiple security detection features), 7,037,606 (security element), and European patent publication EP 1 619 039 (fluorescent latent image transfer film). The entire disclosure of each and every one of these patent documents is hereby incorporated by reference into this specification.

Referring again to FIG. 2, the thermal transfer ribbon 100 is preferably comprised of a backcoat 103. The preparation of backcoats on thermal transfer ribbons is well known and is described, e.g., in U.S. Pat. Nos. 3,900,323 (opaque backcoat), 4,950,641 (thermal transfer printing dyesheet and backcoat composition therefor), 5,821,028 (thermal transfer image receiving material with backcoat), 5,952,107 (backcoat for thermal transfer ribbons), 6,077,594 (thermal transfer ribbon with self generating silicone resin backcoat), 6,245,416 (water soluble silicone resin backcoat for thermal transfer ribbons), and the like. The entire disclosure of each of these United States patents is hereby incorporated by reference into this specification.

Referring again to FIG. 2, the thermal transfer ribbon 100 is also comprised of a support 105 that is similar to the support 14 of FIG. 1. The preparation of such supports for thermal transfer ribbons is well known and is described, e.g., in one or more of the above mentioned published patent documents.

Referring again to FIG. 2, the thermal transfer ribbon 100 is also comprised of a thermal transfer layer 107. The preparation of such thermal transfer layers is well known and is described, e.g., in U.S. Pat. Nos. 4,684,271 (thermal transfer ribbon including an amorphous polymer), 4,744,685 (thermal transfer ribbon and method of making same), 4,816,344 (preparation of fluorescent thermal transfer ribbon), 4,894,283 (reusable thermal transfer ribbon), 4,895,465 (thermal transfer ribbon especially for impressions on rough paper), 4,898,486 (thermal transfer ribbon, especially for impressions on rough paper), 4,923,749 (thermal transfer ribbon), 4,938,617 (thermal transfer ribbon with adhesion layer), 5,017,428 (multiple impression thermal transfer ribbon), 5,047,291 (magnetic thermal transfer ribbon), 5,084,359 (magnetic thermal transfer ribbon), 5,098,350 (magnetic thermal transfer ribbon), 5,352,672 (holographic thermal transfer ribbon), 5,552,231 (thermal transfer ribbon), 5,681,379 (thermal transfer ribbon formulation), 5,843,579 (magnetic thermal transfer ribbon with aqueous ferrofluids), 5,866,637 (magnetic thermal transfer ribbon with non-metallic magnets), 5,932,643 (thermal transfer ribbon with conductive polymers), 5,939,207 (thermal transfer ribbon for high density/high resolution bar code applications), 6,031,021 (thermal transfer ribbon with thermal dye color palette), 6,077,594 (thermal transfer ribbon with self generating silicone resin backcoat), 6,149,747 (ceramic marking system with decals and thermal transfer ribbon), 6,303,228 (thermal transfer ribbon and base film thereof), 6,629,792 (thermal transfer ribbon with frosting ink layer), and the like. The entire disclosure of each of these United States patents is hereby incorporated by reference into this specification.

The thermal transfer layer 107 depicted in FIGS. 2 through 12 may also comprise the particulate conductive metal material described by reference to layer 12 of FIG. 1, and/or it may comprise some or all of the other materials in such layer 12.

Referring again to FIG. 2, it will be seen that thermal transfer ribbon 100 is preferably comprised of a flexible substrate 105 that, in the embodiment depicted, is a polyester support and that is similar to flexible support 14. Substrate 105 may be any substrate typically used in thermal transfer ribbons such as, e.g., the substrates described in U.S. Pat. No. 5,776,280; the entire disclosure of which patent is hereby incorporated by reference into this specification.

In one embodiment, substrate 105 is a flexible material that comprises a smooth, tissue-type paper such as, e.g., 30-40 gauge capacitor tissue. In another embodiment, substrate 32 is a flexible material consisting essentially of synthetic polymeric material, such as poly(ethylene terephthalate) polyester with a thickness of from about 1.5 to about 15 microns which, preferably, is biaxially oriented. Thus, by way of illustration and not limitation, one may use polyester film supplied by the Toray Plastics of America (of 50 Belvere Avenue, North Kingstown, R.I.) as catalog number F53. Thus, e.g., polyester film other than poly(ethylene terephthalate) film may also be used.

By way of further illustration, substrate 105 may be any of the substrate films disclosed in U.S. Pat. No. 5,665,472, the entire disclosure of which is hereby incorporated by reference into this specification. Thus, e.g., one may use films of plastic such as polyester, polypropylene, cellophane, polycarbonate, cellulose acetate, polyethylene, polyvinyl chloride, polystyrene, nylon, polyimide, polyvinylidene chloride, polyvinyl alcohol, fluororesin, chlorinated resin, ionomer, paper such as condenser paper and paraffin paper, nonwoven fabric, and laminates of these materials. These materials, and their properties, are well known to those skilled in the art and are described, e.g., in the “Modern Plastics Encyclopedia ‘92’ (Mid-October 1991 issue, Volume 68, Number 11, published by Modem Plastics, Box 481, Highstown, N.J.).

Affixed to the bottom surface of substrate 105 is backcoating layer 103, which is similar in function to the “backside layer” described at columns 2-3 of U.S. Pat. No. 5,665,472, the entire disclosure of which is hereby incorporated by reference into this specification. This layer 103 is also similar to layer 18 of FIG. 1. Without wishing to be bound to any particular theory, applicants believe that the function of this backcoating layer 103 is to prevent blocking between a thermal backing sheet and a thermal head and, simultaneously, to improve the slip property of the thermal backing sheet.

One may apply backcoating 103 at a coating weight of from about 0.01 to about 2 grams per square meter, with a range of from about 0.02 to about 0.4 grams/square meter being preferred in one embodiment and a range of from about 0.5 to about 1.5 grams per square meter being preferred in another embodiment.

FIG. 3 depicts a thermal transfer ribbon 500 that, in the preferred embodiment depicted, contains one or more different elemental moieties and/or inorganic compounds in its thermal transfer layer 107; in one aspect of this embodiment, such “elemental moieties” and/or compounds are of different sizes and/or concentrations and/or shapes.

Thus, and referring to thermal transfer ribbon 500, it will be seen that copper in the form of platelets 503, and/or copper in the form of nanoparticles 505, and/or silver particles 507, and/or threads 509, and/or silica based microfibers 511, may be present in the topcoat (TC) 107 and can vary in concentration(s). In one embodiment, calcium carbonate moieties 513 are also present in topcoat 107.

Referring again to FIG. 3, it will be seen that undercoat layer 209 may optionally be present in the thermal transfer ribbon 500 and may comprise one or more of such platelets 503 and/or nanoparticles 505 and/or silver particles 507 and/or threads 509 and/or microfibers 511, etc.

In each of FIGS. 2 through 3, a thermal transfer layer 107 is described. As will be apparent to those skilled in the art, the conductive ink layer 12 described by reference to FIG. 1 may be contained in the thermal transfer layer 107, in addition to binders, waxes, etc. Alternatively, the thermal transfer layer 107 depicted in FIGS. 2 through 3 may also comprise the particulate conductive metal material described by reference to layer 12 of FIG. 1, and/or it may comprise some or all of the other materials in such layer 12.

### EXAMPLES

The following examples are presented to illustrate the claimed invention but are not to be deemed limitative thereof. Unless otherwise specified, all parts are by weight, and all temperatures are in degrees Celsius.

### Example 1

A thermal transfer ink was prepared by first heating 37.50 grams of solvent grade toluene (Chemcentral, Chicago, Ill.) to 70 C in a 2 oz glass jar on a combination hot plate and magnetic stirrer. A magnetic stir bar was then placed in the jar, and the stirrer was set to 300 rpm. 1.50 g of Unirez 2980 (a fatty acid dimer-based esteramide resin from Arizona Chemical, Jacksonville, Fla.), 0.19 g of Elvax 250 (an ethylvinylacetate copolymer from Chemcentral, Chicago, Ill.) and 0.18 g of Disperbyk 191 (a polyacrylate copolymer with pigment acidic groups from Dar-Tech, Cleveland, Ohio) were added to the solvent thus prepared, and the lid of the jar was set loosely on the jar to retard solvent evaporation. This mixture was left under heat and agitation for 10 minutes until the solution was homogenous. This solution was of a clear pale yellow color. The solution was then transferred to a half-pint paint can, and 35.63 g of S2-80 (spherical 80 nanometer silver particles from NanoDynamics, Buffalo, N.Y.) was added slowly to avoid splashing; the ink thus produced contained 95 weight percent of metallic material, by dry weight of ink. To this was added 40 g of 0.4-0.6 mm ceramic milling media, and the lip of the paint can placed on top of the can and secured by tapping it down with a plastic tipped hammer. The sealed can was then placed into a Red Devil paint shaker and agitated for three cycles at four minutes each. The ink was tested on a 50 micron grind gauge, and was found to be 0 with no visible scratches whatsoever. The ink was filtered into a fresh half pint paint can using a six inch square section cut from a 400 micron filter bag placed over the mouth of the new can and the ink/media mixture poured through it, collecting the media while transferring the ink into the fresh can.

A backcoated thermal transfer film was prepared by applying a mixture of Lustran SAN31 (a styrene/acrylonitrile copolymer obtained from Ashland Distribution, Tonawanda, N.Y.), Zinc Sterate (Meyers Chemicals Inc, Buffalo, N.Y.), Zelec NK (a neutralized phosphate ester: amine salt from Brentag Northeast Inc., Liverpool, N.Y.), Printex XE2 (a conductive carbon black from Degussa, Marietta, Ohio) and Homogenol L18 (a polycarboxylate surfactant from KAO Specialties Americas, High Point, N.C.) at a coatweight of 0.23 grams per square meter using a gravure coating process to a 5.7 micron thick poly(ethylene terepthalate) film (Toray Plastics America, Providence, R.I.). The thermal transfer ink was then coated via a Meyer rod at 7.50 grams per square meter onto the uncoated side of the thermal transfer film. The ink was dried with a hot air gun until dry to the touch. A label was then prepared by using a Zebra XiIII Plus thermal transfer printer to print the thermal transfer ribbon in a one inch square solid fill pattern onto THERMLfilm SELECT 21940 (a topcoated thermal transfer printable white polyester film coated with a permanent pressure sensitive acrylic adhesive and backed with kraft release liner from FLEXcon, Spencer, Mass.) at a darkness of 26. The print was of a brownish color. The thickness of the ink was measured via a scanning electron microscope to be 2.0 microns. Surface resistivity was tested on a Keithley Model 2010 7½-digit, low-noise, auto ranging digital multimeter (from MetricTest, Hayward, Calif.) using a four point probe (serrated tip probes from Everett Charles Technologies, Los Angeles, Calif.) with the probes spaced 3.83 mm from one another (11.5 mm from first to last probe, measured at the center line) and was measured at 5.00 ohms/square. A soft cloth was then used to gently polish the print; the print turned a lustrous silver color. Surface resistivity was then measured on the polished print using the exact equipment described above and was measured at 0.85 ohms/square.

The conductive ink layer of the ribbon prepared in accordance with this example had a surface resistivity of 23,500 ohms per square. Surprisingly, such ribbon produced a printed product with a surface resistivity of 5 ohms per square before polishing and 0.85 ohms per square after polishing. Without wishing to be bound to any particular theory, applicants believe that the heat that the conductive ink layer was subjected to during thermal printing caused the transferred material to become more conductive.

### Example 2

The procedure of Example 1 was substantially followed, with the exception that the Uni-Rez 2980 and the Elvacs 250 were replaced with 1.86 grams of Synthetic Resin AP (a acetophenone-formaldehyde-condensation resin from Dar-Tech, Cleveland, Ohio), 0.20 grams of Disperbyk 111 were used, 39.19 grams of the S280 silver material were used, and the coating weight for the conductive ink layer was 7.27 grams per square meter. The resulting print had a brownish color. The thickness of the printed ink was measured via scanning electron microscope to be 1.5 microns. Surface resistivity of the unprinted ribbon was in excess of 1,000,000 ohms per square. The resistivity of the printed image was 869,760 ohms/square. A soft cloth was then used to gently polish the print which turned a lustrous silver color. Surface resistivity was then measured on the polished print, and it was 3.00 ohms/square.

### Example 3

The procedure of Example 1 was substantially followed, with the exception that the ink used was comprised of 35.63 grams of C1-500 (spherical 0.50 micron copper particles obtained from NanoDynamics, Buffalo, N.Y.) in place of the S280 silver particles. The thermal transfer ink was coated at 7.38 grams per square meter. Thermally transferred prints from this ink developed no conductivity with the multimeter reading “overflow”; indicating an open circuit.

It was unexpected that copper, which has a conductivity similar to that of silver, produced a product with such poor conductivity.

### Example 4

The procedure of Example 1 was substantially followed with the exception that the ink used comprised 35.63 grams of AC1-510 (5 micron silver coated copper flakes from NanoDynamics, Buffalo, N.Y.) instead of the S280 silver particles (10% silver by dry weight of flakes), and the thermal transfer ink was coated at 6.22 grams per square meter. The conductive ink layer of the ribbon produced in accordance with the procedure of this had a surface resistivity of 0.29 ohms per square. This result is substantially better than the resistivity of the ink layer in the ribbon of Example 3 (in excess of 1,000,000 ohms/square), notwithstanding the fact that the same amount of conductive material (35.63 grams) was used, and notwithanding the fact only about 3.6 grams of silver were used in the silver coated copper flakes.

### Example 5

The procedure of Example 4 was substantially followed, with the exception that the ink was coated onto the substrate at a coatweight of 4.05 grams per square meter. The conductive ink layer in the ribbon had a surface resistivity of 0.8 ohms/square. The surface resistivity of prints from this ink was measured at 0.23 ohms/square without polishing.

### Example 6

The procedure of Example 4 was substantially followed with the exception that the ink was coated onto the substrate at a coatweight of 2.50 grams per square meter. The conductive ink layer in the ribbon had a surface resistivity of 1350 ohms/square. The surface resistivity of prints from this ink was measured at 0.8 ohms/square without polishing.

### Example 7

The procedure of Example 2 was substantially followed with the exception that the ink used was comprised of 35.63 grams of the AC1-510 silver coated copper flakes instead of the S280 silver nanoparticles, and the thermal transfer ink was coated at 4.40 grams per square meter. The conductive ink layer in the ribbon had a surface resistivity of 0.29 ohms/square. The surface resistivity of prints from this ink was measured at 0.16 ohms/square without polishing.

By comparison, the use of the Synthetic Resin AP binder with the S280 silver nanoparticles unexpectedly produced a conductive ink layer in the ribbon with a resistivity in excess of 1,000,000 ohms/square. It is not clear why pure silver material, which is more conductive than a mixture of silver and copper, should produce such a substantially inferior result.

### Example 8

The procedure of Example 1 was substantially followed with the exception that the ink used was comprised of 35.63 grams of C1-6000F (6 micron copper flakes, from NanoDynamics, Buffalo, N.Y.) instead of the 35.63 grams of S280 (silver nanoparticles); and the thermal transfer ink was coated at 6.02 grams per square meter. The conductive ink layer in the ribbon had a surface resistivity in excess of 1,000,000 ohms/square. The surface resistivity of prints from this ink was measured, and it was in excess of 1,000,000 ohms/square without polishing.

It was surprising that copper flakes, which have a conductivity and morphology similar to silver flakes, produced such unexpectedly poor results.

### Example 9

The procedure of Example 1 was substantially followed, with the exception that the ink used comprised 35.63 grams of SF77A (1.25 micron silver flakes from Ferro Corporation, Cleveland, Ohio) instead of the S280 silver nanoparticles, and the thermal transfer ink was coated at 6.45 grams per square meter. The conductive ink layer in the ribbon had a surface resistivity of 0.2 ohms/square. The surface resistivity of prints from this ink was measured at 0.1 ohms/square without polishing.

These results were surprising. In the first place, changing the morphology of the silver material (from spherical particles to flakes) substantially improved the results (the surface resistivity of the unprinted ink layer decreased from 23,500 ohms/square to 0.2 ohms per square). However, merely using conductive flake material is not sufficient to achieve this result. When the silver flake material was replaced by copper flake material (see Example 8), the surface resistivity of the unprinted ink layer increased from 0.2 ohms/square (see this Example 9) to in excess of 1,000,000 ohms/square.

### Example 10

The procedure of Example 1 was substantially followed with the exception that the ink used was comprised of a mixture of 3.56 grams of S2-80 (spherical 80 nanometer silver particles from NanoDynamics, Buffalo, N.Y.) and 32.06 g of AC1-510 (5 micron silver coated copper flakes from NanoDynamics, Buffalo, N.Y.); and the thermal transfer ink was coated at 6.05 grams per square meter. The conductive ink layer in the ribbon had a surface resistivity of 0.29 ohms/square. The surface resistivity of prints from this ink was measured at 0.16 ohms/square without polishing.

### Example 11

A thermal transfer ink was prepared by first heating 37.50 g of solvent grade toluene (Chemcentral, Chicago, Ill.) to 70 C in a 2 oz glass jar on a combination hot plate and magnetic stirrer. A magnetic stir bar was then placed in the jar, and the stirrer was set to 300 rpm. 2.26 g of Unirez 2980 (a fatty acid dimmer-based ester amide resin from Arizona Chemical, Jacksonville, Fla.), 0.38 g of Elvax 250 (an ethyl vinyl acetate copolymer from Chemcentral, Chicago, Ill.) and 0.18 g of Disperbyk 191 (a polyacrylate copolymer with pigment affinic groups from Dar-Tech, Cleveland, Ohio) were added to the solvent thus prepared and the lid of the jar set loosely on the jar to retard solvent evaporation. This mixture was left under heat and agitation for 10 minutes until the solution was homogenous. This solution was of a clear pale yellow color. The solution was then transferred to a half-pint paint can, and 34.68 g of AC1-510 (5 micron silver coated copper flakes from NanoDynamics, Buffalo, N.Y.) was added slowly to avoid splashing; the ink thus produced contained 92.5 weight percent of metallic material, by dry weight of ink. To this was added 40 g of 0.4-0.6 mm ceramic milling media and the lip of the paint can placed on top of the can and secured by tapping it down with a plastic tipped hammer. The sealed can was then placed into a Red Devil paint shaker and agitated for three cycles at four minutes each. The ink was tested on a 50 micron grind gauge with several scratches appearing at the 6 micron mark, which is the upper limit of the particle size of the AC1-510. The ink was filtered into a fresh half pint paint can using a six inch square section cut from a 400 micron filter bag placed over the mouth of the new can and the ink/media mixture was poured through it, collecting the media while transferring the ink into the fresh can.

A backcoated thermal transfer film was prepared by applying a mixture of Lustran SAN31 (a styrene/acrylonitrile copolymer from Ashland Distribution, Tonawanda, N.Y.), zinc stearate (Meyers Chemicals Inc, Buffalo, N.Y.), Zelec NK (a neutralized phosphate ester: amine salt from Brentag Northeast Inc., Liverpool, N.Y.), Printex XE2 (a conductive carbon black from Degussa, Marietta, Ohio) and Homogenol L18 (a polycarboxylate surfactant from KAO Specialities Americas, High Point, N.C.) at a coatweight of 0.23 grams per square meter using a gravure coating process to a 5.7 micron thick poly(ethylene terepthalate) film (Toray Plastics America, Providence, R.I.).

The thermal transfer ink was then coated via a meyer rod at 6.03 grams per square meter onto the uncoated side the thermal transfer film. The ink was dried with a hot air gun until dry to the touch. A label was then prepared by using a Zebra XiIII Plus thermal transfer printer to print the thermal transfer ribbon in a one inch square solid fill pattern onto THERMLfilm SELECT 21940 (a topcoated, thermal transfer printable white polyester film coated with a permanent pressure sensitive acrylic adhesive and backed with kraft release liner from FLEXcon, Spencer, Mass.) at a darkness of 26. Surface resistivity was tested in accordance with the procedure descried in the aforementioned examples.

The conductive ink layer in the ribbon had a surface resistivity of ______ ohms/square. The surface resistivity of prints from this ink was measured at 0.15 ohms/square without polishing.

### Example 12

The procedure of Example 11 was substantially followed with the exception that 2.82 g of Unirez 2980 and 0.75 g of Elvax 250 were added to the solvent. The AC1-510 was reduced to 33.75 grams; the ink thus produced contained 90 weight percent of metallic material, by dry weight of ink. The unprinted conductive ink layer in the ribbon had a surface resistivity 0.29 ohms/square, and the resistivity of the printed square was 0.13 ohms/square.

### Example 13

The procedure of Example 11 was substantially followed with the exception that 1.5 g of Unirez 2980, 0.37 g of Elvax 250 and 0 g of Disperbyk 191 were added to the solvent and 35.63 g of S2-80 (0.08 micron spherical silver particles from Nanodynamics) were substituted for the 34.68 g of AC1-510 silver coated copper flakes, and no dispersing agent was used; the ink thus produced contained 95.0 weight percent of metallic material, by dry weight of ink. The thermal transfer ink was then coated via a meyer rod at 7.5 grams per square meter onto the uncoated side the thermal transfer film. The unprinted ink layer had a resistivity of 1,240,000 ohms/square. The printed ink layer had a resistivity of 4.03 ohms per square.

It is surprising that the silver nanoparticles produce an unprinted resistivity of 1,240,000 ohms per square, but that the silver coated copper flakes produce an unprinted resistivity of 0.29 ohms per square.

### Example 14

The procedure of Example 13 was substantially followed with the exception 35.63 g of AC1-510 silver coated copper flakes were substituted for the S2-80 silver nanoparticles; the ink thus produced contained 95 weight percent of metallic material, by dry weight of ink. The thermal transfer ink was then coated via a meyer rod at 7.0 grams per square meter onto the uncoated side the thermal transfer film. The unprinted ink had a resistivity of 0.2 ohms/square, and the printed ink had a resistivity of 0.13.

The procedure of Example 14 was also comparable to the procedure of Example 4, except that no dispersing agent was used in Example 14; and the results were comparable. By comparison, when the dispersing agent of Example 1 was omitted in the procedure of Example 13, the resisitivity of the unprinted ink layer went from 23,500 ohms/square to 1,240,000 ohms per square.

### Example 15

The procedure of Example 11 was substantially followed with the exception that 4.89 g of Unirez 2980, 0.56 g of Elvax 250 and 0.17 g of Disperbyk 191 were added to the solvent. The AC1-510 was reduced to 31.88 g. The thermal transfer ink was then coated via a meyer rod at 5.75 grams per square meter onto the uncoated side the thermal transfer film; and the ink used contained 85 weight percent of metallic material, by dry weight of ink. The surface resistivity of the unprinted ink was 0.35 ohms/square. Surface resistivity of the printed square was 0.35 ohms/square.

### Example 16

The procedure of Example 15 was substantially followed with the exception that the ink was coated onto the substrate at a coatweight of 2.90 grams per square meter; and the ink used contained 85 weight percent of metallic material, by dry weight of ink. The surface resistivity of the unprinted ink was 31.9 ohms/square. Surface resistivity of the printed square was 15.65 ohms/square.

### Example 17

The procedure of Example 15 was substantially followed with the exception that 6.68 g of Unirez 2980, 0.66 g of Elvax 250 and 0.16 g of Disperbyk 191 were added to the solvent. The AC1-510 was reduced to 30.00 g. The thermal transfer ink was then coated via a meyer rod at 5.75 grams per square meter onto the uncoated side the thermal transfer film; and the ink used contained 80 weight percent of metallic material, by dry weight of ink. The surface resistivity of the unprinted ink was 1.16 ohms/square. Surface resistivity of the printed square was 1.16 ohms/square.

### Example 18

The procedure of Example 17 was substantially followed with the exception that the ink was coated onto the substrate at a coatweight of 2.80 grams per square meter; and the ink used contained 80 weight percent of metallic material, by dry weight of ink. The surface resistivity of the unprinted ink was >1,000,000 ohms/square. Surface resistivity of the printed square was >1,000,000 ohms/square.

### Example 19

The procedure of Example 15 was substantially followed with the exception that 8.49 g of Unirez 2980, 0.73 g of Elvax 250 and 0.15 g of Disperbyk 191 were added to the solvent. The AC1-510 was reduced to 28.13 g. The thermal transfer ink was then coated via a meyer rod at 5.77 grams per square meter onto the uncoated side the thermal transfer film; and the ink used contained 75 weight percent of metallic material, by dry weight of ink. The surface resistivity of the unprinted ink was 6.47 ohms/square. Surface resistivity of the printed square was 4.2 ohms/square.

### Example 20

The procedure of Example 19 was substantially followed with the exception that the ink was coated onto the substrate at a coatweight of 2.78 grams per square meter; and the ink used contained 75 weight percent of metallic material, by dry weight of ink. The surface resistivity of the unprinted ink was >1,000,000 ohms/square. Surface resistivity of the printed square was >1,000,000 ohms/square.

### Example 21

The procedure of Example 15 was substantially followed with the exception that 12.26 g of Unirez 2980, 0.73 g of Elvax 250 and 0.13 g of Disperbyk 191 were added to the solvent. The AC1-510 was reduced to 24.38 g. The thermal transfer ink was then coated via a meyer rod at 5.55 grams per square meter onto the uncoated side the thermal transfer film; and the ink used contained 65 weight percent of metallic material, by dry weight of ink. The surface resistivity of the unprinted ink was >1,000,000 ohms/square. Surface resistivity of the printed square was >1,000,000 ohms/square.

### Example 22

The procedure of Example 21 was substantially followed with the exception that the ink was coated onto the substrate at a coatweight of 2.76 grams per square meter; and the ink used contained 65 weight percent of metallic material, by dry weight of ink. The surface resistivity of the unprinted ink was >1,000,000 ohms/square. Surface resistivity of the printed square was >1,000,000 ohms/square.

### Example 23

A thermal transfer ink was prepared by first heating 37.50 g of solvent grade toluene (Chemcentral, Chicago, Ill.) to 70 C in a 2 oz glass jar on a combination hot plate and magnetic stirrer. A magnetic stir bar was then placed in the jar and the stirrer was set to 300 rpm. 1.50 g of Unirez 2980 (a fatty acid dimmer-based ester amide resin from Arizona Chemical, Jacksonville, Fla.), 0.19 g of Elvax 250 (an ethyl vinyl acetate copolymer from Chemcentral, Chicago, Ill.) and 0.18 g of Disperbyk 191 (a polyacrylate copolymer with pigment affinic groups from Dar-Tech, Cleveland, Ohio) were added to the solvent thus prepared and the lid of the jar set loosely on the jar to retard solvent evaporation. This mixture was left under heat and agitation for 10 minutes until the solution was homogenous. This solution was of a clear pale yellow color. Next, 35.63 g of AC1-510 (5 micron silver coated copper flakes from NanoDynamics, Buffalo, N.Y.) was added slowly to avoid splashing. The ink was then dispersed using a Vibra Cell VCX-600 high intensity ultrasonic processor (Sonics and Materials Inc., Newtown, Conn.). The horn of the ultrasonic processor was lowered into the jar, leaving approximately 5 mm between the bottom of the horn and the bottom of the jar. The ultrasonic processor was set up to use a five second pulse at 50% amplitude with a two second pause between pulses. Dispersion of the ink was obtained by agitation via the ultrasonic processor using the previously described settings for the duration of ten minutes. FOG was tested on a 50 micron grind gauge with several scratches appearing at the 6 micron mark which is the upper limit of the particle size of the AC1-510. A backcoated thermal transfer film was prepared by applying a mixture of Lustran SAN31 (a styrene/acrylonitrile copolymer from Ashland Distribution, Tonawanda, N.Y.), Zinc Sterate (Meyers Chemicals Inc, Buffalo, N.Y.), Zelec NK (a neutralized phosphate ester: amine salt from Brentag Northeast Inc., Liverpool, N.Y.), Printex XE2 (a conductive carbon black from Degussa, Marietta, Ohio) and Homogenol L18 (a polycarboxylate surfactant from KAO Specialities Americas, High Point, N.C.) at a coatweight of 0.23 grams per square meter using a gravure coating process to a 5.7 micron thick poly(ethylene terepthalate) film (Toray Plastics America, Providence, R.I.). The thermal transfer ink was then coated via a meyer rod at 7.50 grams per square meter onto the uncoated side the thermal transfer film. The ink was dried with a hot air gun until dry to the touch. A label was then prepared by using a Zebra XiIII Plus thermal transfer printer to print the thermal transfer ribbon in a one inch square solid fill pattern onto THERMLfilm SELECT 21940 (a topcoated thermal transfer printable white polyester film coated with a permanent pressure sensitive acrylic adhesive and backed with kraft release liner from FLEXcon, Spencer, Mass.) at a darkness of 26. The print was of a brownish color. The thickness of the ink was measured via SEM to be 2.2 microns. Surface resistivity was tested on a Keithley Model 2010 as described in the prior examples.

The ink used in this example contained 95 weight percent of metallic material, by dry weight of ink. The surface resistivity of the unprinted ink was 0.31 ohms/square. Surface resistivity of the printed square was 0.25 ohms/square.

### Example 24

The procedure of Example 1 was substantially followed with the exception that the ink was coated onto the substrate at a coatweight of 7.7 grams per square meter

A label was then prepared by using an Atlantek Model 200 Theraml Response Test System Printer (Atlantak Corporation of Wakefield, R.I., a division of Zebra Corporation of Vernon Hills, Ill.) to print the thermal transfer ribbon of this example in a solid fill pattern onto THERMLfilm SELECT 21940 (a topcoated thermal transfer printable white polyester film coated with a permanent pressure sensitive acrylic adhesive and backed with kraft release liner from FLEXcon, Spencer, Mass.) at a printing speed of 2 cm/sec, a voltage of 21 volts, using a 300 dpi Kyocera model KST-216-8 MPD1 printhead with a resistance of 1329 ohms. With a printing line time of 4 miliseconds and duty cycle of 18% (printing on time per line of 0.72 miliseconds) the printing energy was 7.6 joules/square centimeter. The surface resistivity of the printed ink sample was 2.87 ohms/square.

Printing a thermal transfer ribbon onto a flexible polyester substrate using a conventional thermal transfer printer (such as the Atlantek Model 200) at a printing speed of 2 centimeters per second and a printing energy of 7.6 joules per square centimeter may be used a test to determine whether one a particular thermal transfer ribbon is comprehended by one set of claims presented in this application. If the thermally printed conducive ink layer has a surface resistivity of less than 100 ohms per square, and if it meets the other elements of the claims(s), it is within the scope of such claim(s).

The invention has been described in detail with particular reference to certain preferred embodiments thereof, but it will be understood that variations and modifications can be effected within the spirit and scope of the invention. Some of these variations and modifications are described below.

The thermal transfer ribbon of this invention comprising conductive ink material can be configured to print an antenna onto a substrate such as, e.g., the antenna described in published United States patent application 2003/0038174, the entire disclosure of which is hereby incorporated by reference into this specification. Claim 1 of this application describes: “An improved identification card comprising: . . . at least one antenna affixed to said first side of said core layer, at least one integrated circuit chip electrically connected to said antenna . . . ”

The thermal ribbon may be adapted to print an electroconductive material such as, e.g., the electroconductive material disclosed in U.S. Pat. No. 7,037,476, the entire disclosure of which is hereby incorporated by reference into this specification. This patent discloses a security feature with both electroconductive and electrononconductive material. Either or both of these materials may be incorporated into applicants' thermal transfer layer 107 and used to print a substrate. Such thermal transfer layers could be used to print overt information such a bar code, encrypted text, alphanumerics and the like. The authenticity of the printed overt information could be detected through covert means, such as testing its electrical conductivity. Claim 1 of this patent describes: “1. A security element comprising a carrier material equipped with a first coating of magnetic material forming a first code and a second coating of electroconductive material forming a second code and having in addition a third, optically readable code formed at least in certain areas by a third coating of nonmagnetic, nonelectroconductive material and covering at least partial areas of the security element not covered by a least one of the first coating or the second coating, said three coatings not being distinguishable from each other with the naked eye, wherein the optically readable code and at least one of the first and second coating are perceptible with the naked eye.” The conductive ink layer 12 is adapted to print such electroconductive material.

The thermal ribbon may be adapted to print an embedded electronic circuit such as, e.g., the embedded electronic circuit disclosed in U.S. Pat. No. 6,918,535 the entire disclosure of which is hereby incorporated by reference into this specification. This patent describes a safety paper with an embedded electronic circuit that is used to create forgery-proof securities (such as bank notes). Claim 1 of this patent describes: “1. A safety paper with a) a structure in the form of an electronic circuit (1, 4, 7) making possible a contactless checking of an authenticity feature, b) the circuit (1, 4, 7) comprising an electronic circuit chip and a pattern (7) connected therewith and serving as a sending/receiving antenna that, c) the electronic circuit, in response to a received input signal, is operative to emit emits an output signal indicating the presence of the authenticity feature, d) the and whose pattern (50, 50′) serving as a sending/receiving antenna has the form of being formed as a dipole antenna comprised of two conductor strips (50, 50′) extending along a common straight line, e) which at facing ends thereof are contacted with connecting areas (70, 70′) of the circuit chip (40), f) the conductor strips and are formed by portions of a thin insulating polymer substrate strip that have been made conductive, between whose g) the circuit chip is positioned on an insulating portion, delimited between the facing ends of the conductor strips (50, 50′), the circuit chip (40) is positioned, wherein h) the circuit chip (40) is formed on a thin-ground semiconductor substrate which is arranged on the insulating portion of the polymer substrate strip.” The conductive ink layer 12 is adapted to print such embedded circuit

The thermal ribbon may be adapted to print a microdot such as, e.g., the microdot disclosed in U.S. Pat. No. 6,708,618, the entire disclosure of which is hereby incorporated by reference into this specification. This patent discloses a security feature known as a “microdot.” Such a security feature may comprise applicants' thermal ribbon layer 107 and may be printed onto a substrate; such microdots may be easily incorporated into the thermal transfer layer 107 of a thermal transfer ribbon 101 so long as they preferably do not exceed 20 microns in any on dimension. Preferably, microdots should be thin, flake-like security devices with a thickness less than 1 micron. Such dots would be easily transferred to a receiver sheet in the thermal printing process. Once imaged, these dots would be incorporated into the printed image, providing a covert security element that would not be visible to the human eye and could not be copied using conventional scanners or xerographic copiers. Only with the aid of high magnification microscopes could the presence of such microdots be detected.

Claim 1 of U.S. Pat. No. 6,708,618 describes: “1. An apparatus to be applied to a valuable object for authenticating and preventing counterfeiting comprising: an unique security feature known as a microdot which includes a plurality of randomly scattered microscopic markers, each of said markers constructed as a stand alone self supporting design by a manufacturing technique from the group consisting of etching and molding, said design defines a single pattern of indicia, each of said markers being constructed of only a single thin layer of material; and said microdot to be fixedly applied by securing means onto a valuable object, said microdot to be only observable by using a magnifying apparatus in order to authenticate said object by a comparative examination procedure with a known appearance of said microdot, by said plurality of markers being randomly positioned on each valuable object there is produced a totally unique pattern of said markers for each valuable object.”

The thermal ribbon may be adapted to print a multi-detectable ink composition such as, e.g., the composition disclosed in U.S. Pat. Nos. 3,928,226 and 4,015,131, the entire disclosure of each of which is hereby incorporated by reference into this specification.

U.S. Pat. No. 3,928,226 describes, in claim 1 thereof, “1. A machine-readable marking ink composition having two or more mixed pigments . . . whereby the color of the ink under mixed light is different than the florescent color of the ink when irradiated at the fluorescent wavelength of said fluorescent pigment.” The thermal transfer layer 107 may comprise one or more of the multi-detectable ink compositions of this patent and/or one or more of the multi-detectable ink compositions of some of the other patents discussed in this specification.

The thermal ribbon may be adapted to print quantum dots such as, e.g., the quantum dots described in U.S. Pat. No. 6,633,370, the entire disclosure of which is hereby incorporated by reference into this specification. This patent describes (in its claim 1) “ . . . a quantum dot radius . . . ” “Semiconductor quantum dots” are described in column 1 of this patent, wherein it is disclosed that: “Semiconductor quantum dots are simple inorganic solids typically consisting of a hundred to a hundred thousand atoms. They emit spectrally resolvable energies, have a narrow symmetric emission spectrum, and are excitable at a single wavelength. Semiconductor quantum dots have higher electron affinities than organic polymers, such as those used as hole conductors in current display technology. They offer a distinct advantage over conventional dye molecules in that they are capable of emitting multiple colors of light. In addition, semiconductor quantum dots are size tunable, and when used as luminescent centers for electron hole recombination for electroluminescent illumination, their emission color is also size tunable . . . ”

The thermal ribbon may be adapted to print a radiant energy reflectors such as, e.g., the reflectors disclosed in U.S. Pat. No. 4,044,231, the entire disclosure of which is hereby incorporated by reference into this specification. This patent describes, in claim 1 thereof, “1. A fraud resistant document comprising: a main body, a plurality of radiant energy reflectors overlying said main body in a data area for reflecting incident radiant energy of predetermined characteristics, a magnetic recording member overlying said radiant energy reflectors, said member being substantially transparent to said radiant energy and generally opaque to normal visible light whereby said reflectors are at least partially concealed against detection by the naked eye, and a layer of material on the bottom of said magnetic recording member having a lower reflector-receiving surface interfacing with said reflectors, said layer of material being substantially transparent to said radiant energy and said surface having known general microtopographical characteristics, said reflectors comprising thin elements particle deposited onto said reflector-receiving surface, each element having a reflective surface interfacing with said reflector-receiving surface and having substantially the same microtopographical characteristics as said reflector-receiving surface.” The conductive ink layer 12 may be used to print such radiant energy reflectors.

The thermal ribbon may be adapted to print a sensible material such as, e.g., the sensible material disclosed in U.S. Pat. No. 3,639,166, the entire disclosure of which is hereby incorporated by reference into this specification. This patent describes (in claim 1 thereof) a transfer medium comprised of from about 1 to about 45 weight percent of a “sensible material.” This “sensible material” is discussed in columns 7 and 8 of the patent, wherein it is disclosed that: “The sensible material used in the present invention can be any material which is capable of being sensed visually, by optical means, by photoelectric means, by magnetic means, by electroconductive means, or by any other means sensitive to the sensible material.”

A similar sensible material is disclosed in U.S. Pat. No. 3,663,278. In the abstract of such patent, there is described: “A thermal transfer medium comprising a base having a transferable coating composition thereon. The coating composition comprises a cellulosic polymer, a thermoplastic resin, a plasticizer, and “ . . . about 1 to 4 percent by weight of a sensible material.”

The thermal ribbon may be adapted to print a material that exhibits spectral emissivity variability such as, e.g., the material disclosed in U.S. Pat. No. 7,044,386, the entire disclosure of which is hereby incorporated by reference into this specification. This patent describes (in claim 1 thereof) a method for encoding information on surfaces that involves utilizing at least two patterns with different intrinsic emissivities. In particular, claim 1 of this patent describes: “1. A method for encoding information on surfaces, comprising: providing a surface; applying to the surface a first pattern using a first surface modification that emits energy based on a first intrinsic emissivity value at a given temperature; and applying to the surface a second pattern using a second surface modification that emits energy based on a second intrinsic emissivity value that differs from the first intrinsic emissivity value at the given temperature; the first and second patterns forming an information-encoding sequence of transitions of differential emissivity along a scan path over the patterns that encodes a given set of information; whereby an emissivity sensor that is sensitive to transitions in intrinsic emissivity, when scanned along the scan path over the patterns, will detect emissivity transitions that encode the given set of information regardless of whether any light is present.”

We claim:

1. A thermal transfer ribbon comprised of a support and a conductive ink layer disposed above the support, wherein:
(a) said conductive ink layer is comprised of at least 75 weight percent of particulate conductive metal material and from about 1 to about 25 weight percent of binder, and it has a surface resistivity of less than about 1,000,000 ohms per square;
(b) said conductive ink layer has a thickness of from about 0.1 to about 10 microns;
(c) said particulate conductive metal has a particle size such that least about 95 weight percent of its particles have a maximum dimension smaller than 50 microns; and
(d) when said conductive ink layer is thermally printed onto a flexible polyester substrate at a printing speed of 2 centimeters per second and a printing energy of 7.6 joules per square centimeter, its surface resistivity is less than about 100 ohms/square;

2. The thermal transfer ribbon as recited in claim 1, wherein said particulate metal material is comprised of a noble metal.

3. The thermal transfer ribbon as recited in claim 2, wherein said noble metal is selected from the group consisting of silver, gold, platinum, palladium, iridium, rhenium, mercury, ruthenium, osmium, and mixtures thereof.

4. The thermal transfer ribbon as recited in claim 3, wherein said particulate conductive metal has a melting point of at least 800 degrees Celsius.

5. The thermal transfer ribbon as recited in claim 4, wherein said noble metal is selected from the group consisting of silver, gold, and mixtures thereof.

6. The thermal transfer ribbon as recited in claim 5, wherein, when said conductive ink layer is thermally printed onto a flexible polyester substrate at a printing speed of 2 centimeters per second and a printing energy of 7.6 joules per square centimeter and thereafter polished; said printed and polished conductive ink layer has a surface resistivity is less than about 50 ohm/square;

7. The thermal transfer ribbon as recited in claim 5, wherein said conductive metal particles are comprised of an element that has a reduction potential of at least about 0.5 volts at 25 degrees Celsius and 1 atmosphere pressure; and wherein said conductive ink layer has a thickness of less than about 8 microns.

8. The thermal transfer ribbon as recited in claim 5, wherein when said conductive ink layer is thermally printed onto a flexible substrate at a printing speed of 2 centimeters per second and a printing energy of 7.6 joules per square centimeter, it has a volume resistivity that is less than about 100 microohm-cm;

9. A thermal transfer ribbon comprised of a support and a conductive ink layer disposed above the support, wherein:
(a) said conductive ink layer is comprised of at least 75 weight percent of particulate conductive metal material and from about 1 to about 25 weight percent of binder, and it has a surface resistivity of less than about 100 ohms per square;
(b) said conductive ink layer has a thickness of from about 0.1 to about 10 microns;
(c) said particulate conductive metal has a particle size such that least about 95 weight percent of its particles have a maximum dimension smaller than 50 microns; and
(d) said particulate metal material is comprised of a noble metal.

10. The thermal transfer ribbon as recited in claim 9, wherein said particulate conductive metal material is in the form of a flake.

11. The thermal transfer ribbon as recited in claim 10, wherein said noble metal is selected from the group consisting of silver, gold, and mixtures thereof.

12. The thermal transfer ribbon as recited in claim 11, wherein, when said conductive ink layer is thermally printed onto a flexible polyester substrate at a printing speed of 2 centimeters per second and a printing energy of 7.6 joules per square centimeter, said printed conductive ink layer has a surface resistivity of less than about 10 ohms/square;

13. The thermal transfer ribbon as recited in claim 1, wherein said binder is a thermoplastic binder.

14. The thermal transfer ribbon as recited in claim 13, wherein said conductive ink layer is comprised of from about 1 to about 15 weight percent of said thermoplastic binder.

15. The thermal transfer ribbon as recited in claim 14, wherein said conductive ink layer is comprised of at least about 90 weight percent of said particulate conductive metal material.

16. The thermal transfer ribbon as recited in claim 15, wherein said thermoplastic binder has a softening point of from about 45 to about 150 degrees Celsius.

17. The thermal transfer ribbon as recited in claim 16, wherein said particulate conductive metal material has a particle size such that least about 95 weight percent of its particles have a maximum dimension smaller than 15 microns.

18. The thermal transfer ribbon as recited in claim 10, wherein said particulate conductive material comprises a mixture of a noble metal and a non-noble metal.

19. The thermal transfer ribbon as recited in claim 18, wherein said non-noble metal is copper.

20. The thermal transfer ribbon as recited in claim 19, wherein said noble metal is silver.

21. The thermal transfer ribbon as recited in claim 20, wherein said particulate conductive material is comprised of from about 5 to about 40 weight percent of silver, by total weight of silver and copper.

22. The thermal transfer ribbon as recited in claim 21, wherein said particulate conductive material is comprised of from about 10 to about 20 weight percent of silver, by total weight of silver and copper.

23. The thermal transfer ribbon as recited in claim 22, wherein said silver is coated onto said copper at a coating thickness of from about 0.3 to about 0.7 microns.

24. The thermal transfer ribbon as recited in claim 5, wherein said particulate metal material is in the form of a flake.

25. The thermal transfer ribbon as recited in claim 24, wherein, when said conductive ink layer is thermally printed onto a flexible substrate at a printing speed of 2 centimeters per second and a printing energy of 7.6 joules/square centimeter and has a volume resistivity is less than about 100 micro ohm-cm;

26. The thermal transfer ribbon as recited in claim 25, wherein at least about 90 weight percent of said particulate conductive material is present in said conductive ink layer;

27. The thermal transfer ribbon as recited in claim 26, wherein said binder is a thermoplastic binder with a softening point of from about 45 to about 150 degrees Celsius;

28. The thermal transfer ribbon as recited in claim 5, wherein said particulate conductive metal material has a particle size such that least about 95 weight percent of its particles have a maximum dimension smaller than 100 nanometers.
